(19) United States
(12) Patent Application Publication
(10) Pub. No.: US 2023/0055329 A1
(43) Pub. Date: Feb. 23, 2023

(54) SYSTEMS AND METHODS FOR DYNAMIC CHOICE FILTERING

(71) Applicant: Toyota Research Institute, Inc., Los Altos, CA (US)

(72) Inventors: Emily Sumner, Berkeley, CA (US); Nayeli S. Bravo, Salinas, CA (US); Alex Filipowicz, Mountain View, CA (US); Kent Lyons, Los Altos, CA (US); Yanxia Zhang, Foster City, CA (US)

(73) Assignee: Toyota Research Institute, Inc., Los Altos, CA (US)

(21) Appl. No.: 17/409,188

(22) Filed: Aug. 23, 2021

(51) Int. Cl. G06N 5/04

(52) U.S. Cl. CPC G06N 5/04

(57) ABSTRACT

Systems and methods for dynamically filtering choices include identifying, with an indecisiveness detector module, a state of a user, determining, with the indecisiveness detector module, whether the state of the user includes an indecisive behavior, identifying, with a choice identifier module, a state of an environment of the user, identifying, with the choice identifier module, a set of available choices from the state of the environment, receiving, with a processor, a set of past choices and a set of past user decisions relating to the set of past choices, and generating, with a decision making model, a predicted choice from the set of available choices based on the set of past choices and the set of past user decisions in response to determining that the state of the user includes an indecisive behavior.

### TECHNICAL FIELD

The present disclosure relates to decision making, and more particularly to systems for decision making support.

### BACKGROUND

Individuals often face situations where they must make a choice from a set of available choices. Individuals often are quite good at such decision making, often weighing the pros and the cons of the implications of their decision. This is especially true when the individual is familiar with the set of available choices and/or routinely makes the same decision with regard to the set of available choices.

However, individuals may easily become overwhelmed by the set of available choices. Individuals may be in an indecisive state when the individual is unfamiliar with the set of available choices, is under time pressure, and other scenarios. Individuals typically want to be able to make quick decisions, but this ability may be hindered by having to evaluate a large number of available choices. Having someone or something else make the decision for the individual may result in an unpleasant experience for the user because the user's preferences might not have been taken into account.

Therefore, intelligent strategies for decision making that can identify and overcome user indecisiveness in decision making are desired.

### SUMMARY

In accordance with one embodiment of the present disclosure, a method for dynamically filtering choices includes identifying, with an indecisiveness detector module, a state of a user, determining, with the indecisiveness detector module, whether the state of the user includes an indecisive behavior, identifying, with a choice identifier module, a state of an environment of the user, identifying, with the choice identifier module, a set of available choices from the state of the environment, receiving, with a processor, a set of past choices and a set of past user decisions relating to the set of past choices, and generating, with a decision making model, a predicted choice from the set of available choices based on the set of past choices and the set of past user decisions in response to determining that the state of the user includes an indecisive behavior.

In accordance with another embodiment of the present disclosure, a system for dynamically filtering choices includes a processor, a memory module communicatively coupled to the processor, an indecisiveness detector module communicatively coupled to the processor, a choice identifier module communicatively coupled to the processor, a decision making model communicatively coupled to the processor, and a set of machine-readable instructions stored on the memory module. The machine-readable instructions cause the processor to perform operations including identifying, with the indecisiveness detector module, a state of a user, determining, with the indecisiveness detector module, whether the state of the user includes an indecisive behavior, identifying, with the choice identifier module, a state of an environment of the user, identifying, with the choice identifier module, a set of available choices from the state of the environment, receiving, with the processor, a set of past choices and a set of past user decisions relating to the set of past choices, and generating, with the decision making model, a predicted choice from the set of available choices based on the set of past choices and the set of past user decisions in response to determining that the state of the user includes an indecisive behavior.

In accordance with yet another embodiments of the present disclosure, a non-transitory machine-readable medium includes machine-readable instructions that, when executed by a processor, cause the processor to perform operations including identifying, with an indecisiveness detector module, a state of a user, determining, with the indecisiveness detector module, whether the state of the user includes an indecisive behavior, identifying, with a choice identifier module, a state of an environment of the user, identifying, with the choice identifier module, a set of available choices from the state of the environment, receiving, with the processor, a set of past choices and a set of past user decisions relating to the set of past choices, and generating, with a decision making model, a predicted choice from the set of available choices based on the set of past choices and the set of past user decisions in response to determining that the state of the user includes an indecisive behavior.

Although the concepts of the present disclosure are described herein with primary reference to physical locations, it is contemplated that the concepts will enjoy applicability to any location where choices are presented. For example, and not by way of limitation, it is contemplated that the concepts of the present disclosure will enjoy applicability to an online store, like a physical store.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts an example system for dynamically filtering choices, according to one or more embodiments shown and described herein;

FIG. 2 depicts an example method for dynamically filtering choices, according to one or more embodiments shown and described herein;

FIG. 3 depicts an example method for generating a ranked list of predicted choices from a set of available choices, according to one or more embodiments shown and described herein; and

FIG. 4 depicts an example scenario utilizing the system of FIG. 1 and implementing the methods of FIGS. 2 and 3, according to one or more embodiments shown and described herein.

### DETAILED DESCRIPTION

The embodiments disclosed herein include methods, systems, and non-transitory computer-readable mediums having instructions for dynamically filtering choices. In embodiments disclosed herein, the system may be embodied in a server that dynamically filters choices. The server may include an indecisiveness detector module, a choice identifier module, and a decision making model. The server may identify a state of the user and determine whether that state includes an indecisive behavior. The server may use sensors of the indecisiveness detector module to identify the state of the user. The server may use processors of the indecisiveness detector module to determine whether the state of the user includes an indecisive behavior. For example, the indecisiveness detector module may have a gaze monitor to track the gaze of the user and may determine that the user is in an indecisive state when detecting a repeated gaze on one or more choices.

When the indecisive behavior is determined, the server may identify a state of an environment of the user and identify a set of available choices from the state of the environment. The server may use sensors of the choice identifier module to identify the state of the environment. The server may use image processing models of the choice identifier module to identify the set of available choices from the state of the environment. For example, the choice identifier module may have a camera to capture an image of the environment and may identify the choices in the image by analyzing the image with an image recognition model.

However, to account for the user's preferences in dynamically filtering choices, the server may also include a decision making model. Accordingly, a decision making model may be an artificial neural network trained to predict the choices a user would make from a set of available choices. The server may receive context information including a set of past choices and a set of past user decisions relating to the past choices. The decision making model may be trained based on the set of past choices and the set of past user decisions. The server may then generate a predicted choice from the set of available choices with the trained decision making model. The server may also or instead generate a plurality of predicted choices to create a ranked list of predicted choices. Based on the user's selection from the set of available choices, the decision making model may be updated to incorporate the selected choice for enhancing subsequent generating of predicted choices.

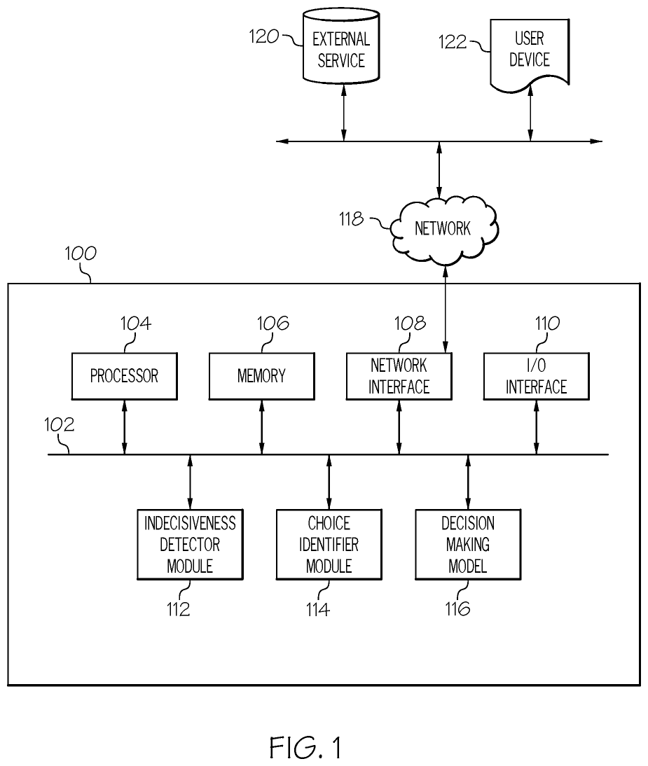

Referring now to FIG. 1, an example system 100 for dynamically filtering choices is schematically depicted. The system 100 may include a processor 104, memory 106, input/output (I/O) interface 110, and network interface 108. The system 100 may also include a communication path 102 that communicatively couples the various components of the system 100. The system 100 may be a physical computing device, such as a server. The system 100 may also or instead be a virtual machine existing on a computing device, a program operating on a computing device, or a component of a computing device. The system 100 may be configured to dynamically filter choices and carry out the methods as described herein.

The processor 104 may include one or more processors that may be any device capable of executing machine-readable and executable instructions. Accordingly, each of the one or more processors of the processor 104 may be a controller, an integrated circuit, a microchip, or any other computing device. The processor 104 is coupled to the communication path 102 that provides signal connectivity between the various components of the system 100. Accordingly, the communication path 102 may communicatively couple any number of processors of the processor 104 with one another and allow them to operate in a distributed computing environment. Specifically, each processor may operate as a node that may send and/or receive data. As used herein, the phrase “communicatively coupled” means that coupled components are capable of exchanging data signals with one another such as, e.g., electrical signals via a conductive medium, electromagnetic signals via air, optical signals via optical waveguides, and the like.

The communication path 102 may be formed from any medium that is capable of transmitting a signal such as, e.g., conductive wires, conductive traces, optical waveguides, and the like. In some embodiments, the communication path 102 may facilitate the transmission of wireless signals, such as Wi-Fi, Bluetooth®, Near-Field Communication (NFC), and the like. Moreover, the communication path 102 may be formed from a combination of mediums capable of transmitting signals. In one embodiment, the communication path 102 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The memory 106 is coupled to the communication path 102 and may contain one or more memory modules comprising RAM, ROM, flash memories, hard drives, or any device capable of storing machine-readable and executable instructions such that the machine-readable and executable instructions can be accessed by the processor 104. The machine-readable and executable instructions may comprise logic or algorithms written in any programming language of any generation (e.g., 1GL, 2GL, 3GL, 4GL, or 5GL) such as, e.g., machine language, that may be directly executed by the processor 104, or assembly language, object-oriented languages, scripting languages, microcode, and the like, that may be compiled or assembled into machine-readable and executable instructions and stored on the memory 106. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any computer programming language, as pre-programmed hardware elements, or as a combination of hardware and software components.

The input/output interface, or I/O interface 110, is coupled to the communication path 102 and may contain hardware and software for receiving input and/or providing output. Hardware for receiving input may include devices that send information to the system 100. For example, a keyboard, mouse, scanner, and camera are all I/O devices because they provide input to the system 100. Software for receiving inputs may include an on-screen keyboard and a touchscreen. Hardware for providing output may include devices from which data is sent. For example, a monitor, speaker, and printer are all I/O devices because they output data from the system 100.

The network interface 108 includes network connectivity hardware for communicatively coupling the system 100 to the network 118. The network interface 108 can be communicatively coupled to the communication path 102 and can be any device capable of transmitting and/or receiving data via a network 118 or other communication mechanisms. Accordingly, the network interface 108 can include a communication transceiver for sending and/or receiving any wired or wireless communication. For example, the network connectivity hardware of the network interface 108 may include an antenna, a modem, an Ethernet port, a Wi-Fi card, a WiMAX card, a cellular modem, near-field communication hardware, satellite communication hardware, and/or any other wired or wireless hardware for communicating with other networks and/or devices.

The system 100 may be communicatively coupled to a user device 122 and/or an external service 120 by a network 118. The network 118 may be a wide area network, a local area network, a personal area network, a cellular network, a satellite network, an ad hoc network, and the like.

The indecisiveness detector module 112 is connected to the communication path 102 and contains hardware and/or software for detecting when the user is acting indecisive. The indecisiveness detector module 112 may identify a state of the user with data such as a visual, a biometric, an interaction, an eye gaze, an audio recording, and any other user-identifiable data. The indecisiveness detector module 112 may have sensors to identify the state of the user, such as a camera, a heart rate sensor, an eye gaze monitor, a microphone, and any other sensor that can receive user-identifiable data. A state of the user is any mental condition of the user, as may be identified by the user's physical responses. To determine whether a user is in an indecisive state, the indecisiveness detector module 112 may analyze the data relating to the state of the user in comparison to data of known states of indecisiveness. The indecisiveness detector module 112 may have a machine learning model for identifying indecisive behavior exhibited in the state of the user. For example, if the indecisiveness detector module 112 captures a visual or an eye gaze with a camera and/or an eye gaze monitor, the indecisiveness detector module 112 may identify a repeated interaction (e.g., reaching) with a choice or repeated eye gaze on a choice by sending the visual or the eye gaze as input to a machine learning model trained to identify repeated interactions and/or eye gazes. If the indecisiveness detector module 112 captures an audio recording with a microphone, the indecisiveness detector module 112 may identify a manual user indication of indecisiveness (e.g., “I don't know which to pick”) by sending the audio recording as input to a natural language processing model trained to identify speech and detect whether a user is stating that the user is in an indecisive state. If the indecisiveness detector module 112 captures a biometric with a biometric sensor (e.g., heart rate sensor), the indecisiveness detector module 112 may identify a lack of interaction with the set of available choices (e.g., steady pulse with no indication of physical movement or increased pulse due to stress of the decision) by sending the biometric data as input to a machine learning model trained to identify steady or elevated heart rate in response to a stimulus (e.g., a decision making scenario) and detect whether a user's heart rate is steady or elevated for a threshold period of time.

The choice identifier module 114 is connected to the communication path 102 and contains hardware and/or software for identifying a set of choices in an environment. The choice identifier module 114 may identify a state of the environment with data such as a visual, an address, a current time, and any other environmental data. The choice identifier module 114 may have sensors to identify the state of the environment, such as a camera, a GPS locator, a clock, and any other sensor that can sense any state of the environment. To identify a set of choices from the state of the environment, the choice identifier module 114 may analyze the data relating to the state of the environment in comparison to data of known choices. The choice identifier module 114 may have an image recognition model for analyzing a visual. For example, if the choice identifier module 114 receives a visual with a camera (e.g., a photo of the user's view from a clothing store captured from a user device 122), the choice identifier module 114 may identify choices (e.g., clothing options) by sending the visual (e.g., the photo) as input to an image recognition model trained to recognize objects in an image (e.g., a list of shirts from the photo) from a training data of similar objects (e.g., a set of images of shirts). In some embodiments, the visual may be a screenshot from an online environment (e.g., an online store). The choice identifier module 114 may also or instead receive an address from a GPS location as well as a processor 104, and/or a shared processor, to analyze the address for choices. For example, if the choice identifier module 114 identifies an address with a GPS locator (e.g., an address of a clothing store), the processor may retrieve a list of options available at the address (e.g., a list of clothes available at the clothing store) from an external service 120 (e.g., an online database). In some embodiments, the address may be an electronic address (e.g., www.clothing-store.example). After a set of choices has been identified, the choice identifier module 114 may filter the choices to available choices by considering a current time. For example, if the choices identified are food choices at a restaurant, the choices vary depending on the time of day. Instead of the choice identifier module 114 outputting all possible food choices from the restaurant, the choice identifier module 114 may filter the choices to breakfast choices if the time is before noon.

The decision making model 116 is connected to the communication path 102 and contains hardware and/or software for generating a predicted choice from the set of available choices in response to determining that the state of the user includes an indecisive behavior. To generate a predicted choice, decision making model 116 may be an artificial neural network trained based on at least a set of past choices of the user and a set of past user decisions relating to the set of past choices. Training the decision making model 116 allows the decision making model 116 to receive a set of available choices as an input and output a prediction of what the user would decide based on the past user decisions relating to the set of past choices. In some embodiments, the decision making model 116 may be a different kind of model such as a decision tree, a Bayes classifier, a support vector machine, a convolutional neural network, or the like.

The external service 120 may be communicatively connected to the system 100 via network 118. The external service 120 may be one or more of any services that are utilized by the system 100. A service may include remote storage, distributed computing, and any other task performed remotely from the system 100 and on behalf of the system 100.

The user device 122 may generally include a processor, memory, network interface, I/O interface, sensors, and communication path. Each user device 122 component is similar in structure and function to its system 100 counterparts, described in detail above and will not be repeated. The user device 122 may be communicatively connected to the system 100 via network 118. Multiple user devices may be communicatively connected to one or more servers via network 118. For example, an example user device 122 may be a pair of smart glasses. The I/O interface of the smart glasses may include a camera for capturing a state of the environment of the user, such as a visual of the environment. The smart glasses may also include sensors for capturing a state of the user, such as biometrics. The memory of the smart glasses may store the visual and biometrics while the network interface attempts to transmit the visual and biometrics to the system 100, via network 118, for processing. Processing may include the system 100 performing the steps of method 200. The results of the processing may be transmitted to the smart glasses by the system 100, via network 118, for presentation to the user by the smart glasses. It should be noted that the user device 122 is not limited to smart glasses and may include any other kind of personal electronic device, such as a smart watch.

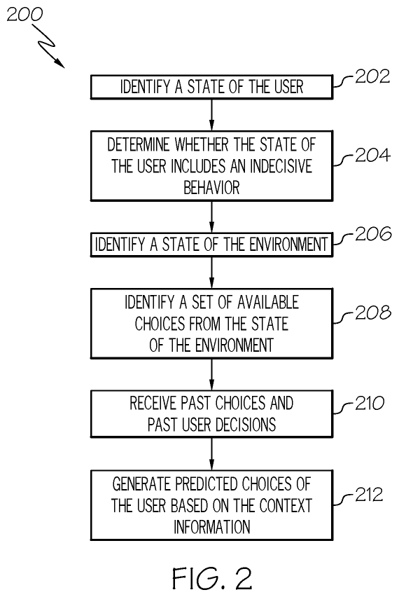

Referring now to FIG. 2, an example method 200 for dynamically filtering choices is depicted. The method 200 may be in the form of machine-readable instructions stored in a non-transitory machine-readable medium, such as memory 106. The method 200 may be performed by a system 100, such as a server, in connection with a user device 122.

In step 202, the system 100 identifies a state of the user. The system 100 may include an indecisiveness detector module 112 that contains hardware and/or software for detecting when the user is acting indecisive. A state of the user is any mental condition of the user, as may be identified by the user's physical responses. Accordingly, the indecisiveness detector module 112 may identify a state of the user with data such as a visual, a biometric, an interaction, an eye gaze, an audio recording, and any other user-identifiable data. The indecisiveness detector module 112 may have sensors to identify the state of the user, such as a camera, a heart rate sensor, a motion sensor, an eye gaze monitor, a microphone, and any other sensor that can receive user-identifiable data.

In step 204, the system 100 determines whether the state of the user includes an indecisive behavior. To determine whether a user is in an indecisive state, the indecisiveness detector module 112 may analyze the data relating to the state of the user in comparison to data of known states of indecisiveness. The indecisiveness detector module 112 may have a machine learning model for identifying indecisive behavior exhibited in the state of the user. The machine learning model may be a neural network that engages in supervised machine learning and is trained using a labeled dataset of user data indicating whether the user is or is not in an indecisive state. The labeled dataset may include examples of a repeated eye gaze on a choice, a repeated interaction with a choice, a lack of interaction with the set of available choices for a threshold period of time, and/or a manual user indication of indecisiveness from a variety of data sources such as a visual, a biometric, an interaction, an eye gaze, and/or an audio recording. For example, if the indecisiveness detector module 112 captures a visual of the user (e.g., a video) with a camera, the machine learning model of the indecisiveness detector module 112 may identify a repeated interaction with a choice (e.g., false starts, such beginning to reach then pausing). If the indecisiveness detector module 112 captures an audio recording with a microphone, the machine learning model of the indecisiveness detector module 112 may identify a manual user indication of indecisiveness (e.g., “I don't know which to pick”).

In step 206, the system 100 identifies a state of the environment. The system 100 may include a choice identifier module 114 that contains hardware and/or software for identifying a state of an environment and identifying a set of choices in the state of the environment. An environment may be physical (e.g., a store) or virtual (e.g., a website). A state of the environment is any items that may be present in the environment. The choice identifier module 114 may identify a state of the environment with data such as a visual, an address, a current time, and any other environmental data. Accordingly, the choice identifier module 114 may have sensors to identify the state of the environment, such as a camera, a GPS locator, a clock, and any other sensor that can sense any state of the environment.

In step 208, the system 100 identifies a set of available choices from the state of the environment. To identify a set of choices from the state of the environment, the choice identifier module 114 may analyze the data relating to the state of the environment in comparison to data of known choices. For example, the choice identifier module 114 may have an image recognition model for analyzing a visual. If the choice identifier module 114 receives a visual captured with a camera of the user's view in a clothing store, the choice identifier module 114 may identify choices in clothing options by sending the photo as input to an image recognition model trained to recognize clothing in a visual from a training data of other clothes. In some embodiments, the visual may be a screenshot from an online environment (e.g., an online store) and the state of the user may be an interaction via a mouse or other computer input device.

To identify a set of choices from the state of the environment, the choice identifier module 114 may also or instead retrieve information relating to an address identified in step 206. The choice identifier module 114 may receive GPS location information from a user device 122 to receive an address of the environment the user is located in as well as a processor 104 to analyze the address for choices. For example, if the choice identifier module 114 identifies an address of a clothing store that the user is in based on GPS location, the processor 104 may retrieve a list of clothes available at the clothing store from an external service 120 such as an online database. In some embodiments, the address may be an electronic address, such as www.clothing-store.example.

After a set of choices has been identified, the choice identifier module 114 may filter the set of choices to available choices by considering a current time. For example, if the choices identified are food choices at a restaurant, the choices vary depending on the time of day. Instead of the choice identifier module 114 outputting all possible food choices from the restaurant, the choice identifier module 114 may filter the choices to breakfast choices if the time is before noon.

In step 210, the system 100 receives a set of past choices and a set of past user decisions relating to the set of past choices. The set of past choices may be past choices from the user in situations where the user made a decision from a set of choices. The set of past user decisions may be past decisions from the user relating and corresponding to the set of past choices. The past may include any amount of time sufficient to gather enough choices and decisions to create a training data set for the decision making model 116. For example, a period of months. In some embodiments, the set of past choices and past decisions may include data from other users.

For example, if the decision making model 116 does not have sufficient data from the user to use as a training data set, the training data set may be supplemented or replaced with past choices and past decisions from other users.

In step 212, the system 100 generates a predicted choice of the user from the set of available choices based on the set of past choices and the set of past user decisions in response to determining that the state of the user includes an indecisive behavior. To generate a predicted choice, decision making model 116 may be an artificial neural network trained based on at least a set of past choices of the user and a set of past user decisions relating to the set of past choices from step 210. Training the decision making model 116 allows the decision making model 116 to receive a set of available choices as an input and output a prediction of what the user would decide based on the past user decisions relating to the set of past choices. In some embodiments, the decision making model 116 may be a different kind of model such as a decision tree, a Bayes classifier, a support vector machine, a convolutional neural network, or the like.

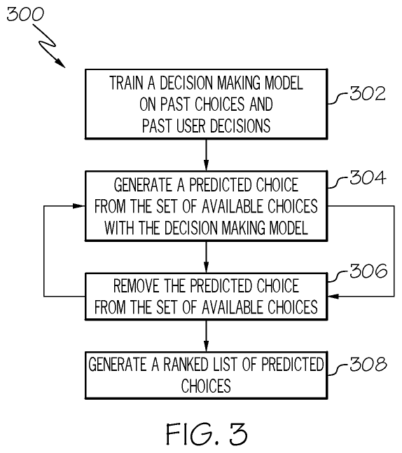

Referring now to FIG. 3, an example method 300 for generating a predicted choice from a set of available choices is depicted. To increase the likelihood that the system 100 will generate a choice that the user might prefer, the system 100 may generate a list of predicted choices from the set of available choices. The system 100 may rank the list to indicate to the user which choice may be the most preferable for the user.

In step 302, the system 100 trains a decision making model 116. The decision making model 116 may be an artificial neural network. In some embodiments, the decision making model 116 may be a different kind of model such as a decision tree, a Bayes classifier, a support vector machine, a convolutional neural network, or the like.

Training the decision making model 116 allows the decision making model 116 to receive a set of available choices as an input and output a prediction of what the user would decide based on the past user decisions relating to the set of past choices. Training may comprise creating a training data set of at least a set of past choices of the user and a set of past user decisions relating to the set of past choices from step 210. Using past choices of the user and past user decisions allows the system 100 to generate predicted choices based on the preferences of the user because the past decisions of the user relating to the set of past choices reflect the user's preferences in decision making. If sufficient data is not available, the training data set may be supplemented with a set of past choices and a set of past user decisions from one or more other users. The sufficiency of data may be predetermined based on an amount of time past and/or a number of decisions made. For example, the system 100 may require one year's worth of data to train the decision making model 116.

In step 304, the system 100 generates a predicted choice from the set of available choices with the decision making model 116. The decision making model 116 may receive as input the set of available choices from the state of the environment as identified in step 208. The decision making model 116 may output a predicted choice by analyzing the set of available choices and selecting a choice that relates to the set of available choices in a relationship similar to the set of past user decisions and the set of past choices as determined by the training of step 302.

In step 306, the system 100 removes the predicted choice from the set of available choices. Removing the predicted choice from the set of available choices prevents subsequent generations of predicted choices from selecting a previously predicted choice. Although the set of available choices has been reduced, the training of the decision making model 116 is unchanged. That is, the decision making model 116 retains its training from step 302 and merely performs step 304 on a smaller set of available options. For example, if the set of available choices includes choices A, B, C, and D and choice A is selected, then only choices B, C, and D remain in the set of available choices after performing step 306. It should be understood that predicted choices are only removed from the set of available choices for a particular instance of generating a ranked list. That is, the set of available choices is only modified for purposes of performing the method 300.

In step 308, the system 100 generates a ranked list of choices. After removing the predicted choice from the set of available choices, step 304 and step 306 may be repeated for a predetermined number of repetitions to generate a ranked list of predicted choices. The number of repetitions is based on the number of items in the ranked list that the system 100 is configured to generate. Each repetition is ranked a position lower than the previous repetition. For example, if the ranked list should contain 5 choices, step 304 and step 306 should be performed 5 times. The predicted choice of the first performance of step 304 and step 306 would be ranked first, the predicted choice of the second performance of step 304 and step 306 would be ranked second, and so on until step 304 and step 306 are performed for the predetermined number of repetitions. In some embodiments, the ranked list generated in step 308 may be provided to the user device 122 for output onto an electronic display to display the ranked list of predicted choices to the user for the user to select a choice. In some embodiments, the ranked list generated in step 308 may be provided for output onto an electronic display connected to the system 100 via I/O interface 110 to display the ranked list of the predicted choices to the user for the user to select a choice.

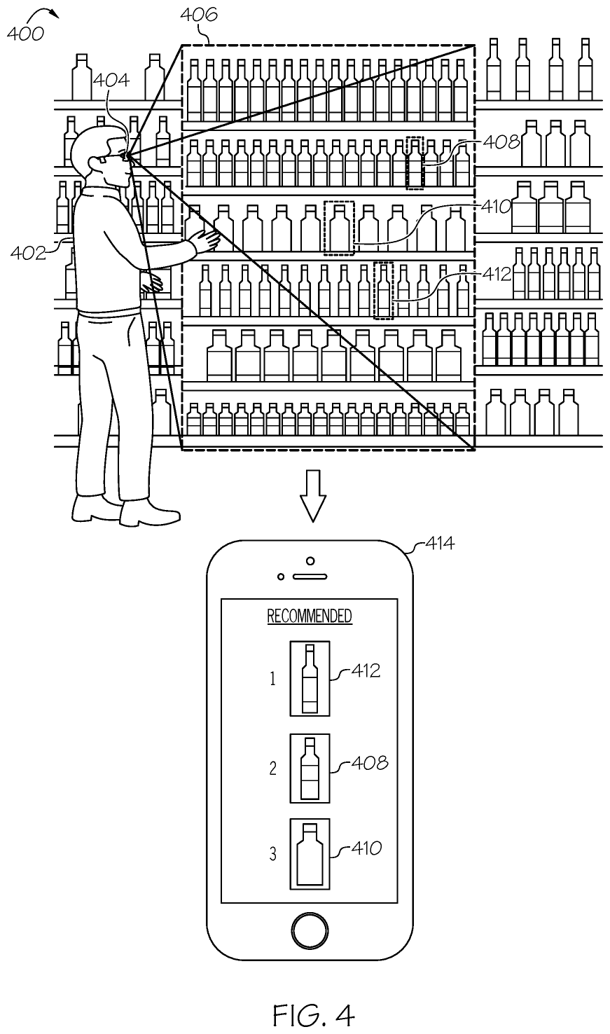

Referring now to FIG. 4, an example scenario 400 utilizing the system of FIG. 1 and implementing the methods of FIGS. 2 and 3 is depicted. In the scenario 400, a user 402 is shopping at a grocery store. Particularly, the user 402 is making a decision about which food items in a visual 406 of food items to pick. The user 402 may be wearing smart glasses 404 that function as a user device 122. The smart glasses 404 may include a camera for capturing a state of the environment, such as visual 406 of the environment. The smart glasses 404 may also include sensors for capturing a state of the user 402, such as biometrics. The user may also have a smart device 414, such as a smartphone, that functions as a system 100. The smart glasses 404 may transmit the sensed data to the smart device 414, for processing. Processing may include the smart device 414 performing the steps of method 200. The results of the processing may be transmitted to the smart glasses 404 by the smart device 414 for presentation to the user by the smart glasses 404. The user 402 may make indicate the selection on the smart device 414 via I/O interface 110 connected to a touch screen of the smart device 414.

In step 202, the smart device 414 identifies a state of the user 402. The smart device 414 may include an indecisiveness detector module 112 that contains hardware and/or software for detecting when the user is acting indecisive. The indecisiveness detector module 112 may identify a state of the user 402 with data such as a visual, a biometric, an interaction, an eye gaze, an audio recording, and any other user-identifiable data. The indecisiveness detector module 112 may have sensors to identify the state of the user, such as a camera, a heart rate sensor, a motion sensor, an eye gaze monitor, a microphone, and any other sensor that can receive user-identifiable data. In scenario 400, the smart glasses 404 include at least a camera and an eye gaze sensor. The camera may capture a visual 406 that may include user 402 or parts of the user 402. The eye gaze sensor may capture a different visual of the eyes of the user 402.

In step 204, the smart device 414 determines whether the state of the user includes an indecisive behavior. To determine whether a user is in an indecisive state, the indecisiveness detector module 112 may analyze the data relating to the state of the user in comparison to data of known states of indecisiveness. The indecisiveness detector module 112 may have a machine learning model for identifying indecisive behavior exhibited in the state of the user. The machine learning model may be a neural network that engages in supervised machine learning and is trained using a dataset of user data indicating whether the user is or is not in an indecisive state. The dataset may include examples of a repeated eye gaze on a choice, a repeated interaction with a choice, a lack of interaction with the set of available choices for a threshold period of time, and/or a manual user indication of indecisiveness from a variety of data sources such as a visual, a biometric, an interaction, an eye gaze, and/or an audio recording. In scenario 400, the user 402 is reaching for an object. A camera of the smart glasses 404 may detect the arm of the user 402 reaching towards multiple food items. An eye gaze sensor of the smart glasses 404 may detect the eye gaze of the user 402 scanning the food items in the visual 406. The indecisiveness detector module 112 may consider these actions to be indicative of indecisiveness because it is trained to recognized these patterns of movements to be indicative of indecisiveness.

In step 206, the smart device 414 identifies a state of the environment. The smart device 414 may include a choice identifier module 114 that contains hardware and/or software for identifying a state of an environment and identifying a set of choices in the state of the environment. The choice identifier module 114 may identify a state of the environment with data such as a visual, an address, a current time, and any other environmental data. Accordingly, the choice identifier module 114 may have sensors to identify the state of the environment, such as a camera, a GPS locator, a clock, and any other sensor that can sense any state of the environment. In scenario 400, the camera of the smart glasses 404 may capture a visual 406 (e.g., a photo or video) comprising a plurality of food items on a shelf. The visual 406 is representative of the state of the environment. The smart glasses 404 may also have a GPS locator to generate an address of the location of the user 402.

In step 208, the smart device 414 identifies a set of available choices from the state of the environment. To identify a set of choices from the state of the environment, the choice identifier module 114 may analyze the data relating to the state of the environment in comparison to data of known choices with an image recognition model, for example. To identify a set of choices from the state of the environment, the choice identifier module 114 may also or instead retrieve information relating to an address identified in step 206. After a set of choices has been identified, the choice identifier module 114 may filter the set of choices to available choices by considering a current time. In scenario 400, the state of the environment may include the visual 406 and the address. The choice identifier module 114 analyzes the visual 406 with an image recognition model, for example, trained to identify food items. The choice identifier module 114 may also query on external service 120, such as an online database, for choices available at the address.

In step 210, the smart device 414 receives a set of past choices and a set of past user decisions relating to the set of past choices. The set of past choices may be past choices from the user 402 in situations where the user 402 made a decision from a set of choices. The set of past user decisions may be past decisions from the user 402 relating and corresponding to the set of past choices. The past may include any amount of time sufficient to gather enough choices and decisions to create a training data set for the decision making model 116. For example, the set of past choices may be the food items from grocery stores that the user 402 has visited in the past year, and the set of past user decisions may be the food items that the user 402 has purchased in the past year.

In step 212, the smart device 414 generates a predicted choice from the set of available choices based on the set of past choices and the set of past user decisions in response to determining that the state of the user includes an indecisive behavior. To generate a predicted choice, decision making model 116 may be an artificial neural network trained based on at least the data received in step 210. In scenario 400, the smart device 414 may receive the food items identified in step 208 as input to the decision making model 116. The smart device 414 may decide that the user would choose food item 412 based on the past shopping habits of the user 402.

In some embodiments, the smart device 414 may continue with method 300 to generate a ranked list of predictions from the user 402 to choose from. Step 302 may be performed in step 210 and step 212, and step 304 may be performed in step 212.

In step 306, the smart device 414 removes the predicted choice from the set of available choices. Removing the predicted choice from the set of available choices prevents subsequent generations of predicted choices from selecting a previously predicted choice without modifying the training of the decision making model. In scenario 400, the smart device 414 removes the first predicted option, food item 412, from the set of available choices so that it cannot be picked when generating the second and third predicted options.

In step 308, the smart device 414 generates a ranked list of choices. After removing the predicted choice from the set of available choices, generating a predicted choice and removing the predicted choice from the set of available choices may be repeated for a predetermined number of repetitions to generate a ranked list of predicted choices. Each repetition is ranked a position lower than the previous repetition. In scenario 400, the smart device 414 is configured to generate a ranked list of the top 3 food items that the user 402 is most likely to choose from the visual 406. Accordingly, after the smart device 414 makes the first prediction of food item 412, the food item 412 is removed from the set of available choices. After the smart device 414 makes the second prediction of food item 408, the food item 408 is removed from the set of available choices. The smart device 414 then makes the third prediction of food item 410. It should be noted that the size of the ranked list is not limited to 3 and may be any number.

The ranked list generated in step 308 may be provided to the user device 122 for output onto an electronic display to display the ranked list of predicted choices to the user for the user to select a choice. Additionally or alternatively, the ranked list generated in step 308 may be output onto an electronic display of the smart device 414 for the user to select a choice. When the user 402 selects a choice, such as food item 412, the smart device 414 may receive the selected choice and update the decision making model 116 to account for the selected choice along with the other available choices. Updating the decision making model 116 to incorporate the selected choice may enhance subsequent generating of predicted choices.

It should now be understood that embodiments disclosed herein include methods, systems, and non-transitory computer-readable mediums having instructions for dynamically filtering choices. The system may identify a state of the user and determine whether that state includes an indecisive behavior. The server may use sensors of the indecisiveness detector module to identify the state of the user. The server may use processors of the indecisiveness detector module to determine whether the state of the user includes an indecisive behavior.

When the indecisive behavior is determined, the server may identify a state of an environment of the user and identify a set of available choices from the state of the environment. The server may use sensors of the choice identifier module to identify the state of the environment. The server may use image processing models of the choice identifier module to identify the set of available choices from the state of the environment.

To account for the user's preferences in dynamically filtering choices, the server may also include a decision making model. Accordingly, a decision making model may be an artificial neural network trained to predict the choices a user would make from a set of available choices. The server may receive context information including a set of past choices and a set of past user decisions relating to the past choices. The decision making model may be trained based on the set of past choices and the set of past user decisions. The server may then generate a predicted choice from the set of available choices with the trained decision making model. The server may also or instead generate a plurality of predicted choices to create a ranked list of predicted choices. Based on the user's selection from the set of available choices, the decision making model may be updated to incorporate the selected choice for enhancing subsequent generating of predicted choices.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A method for dynamically filtering choices, comprising:
identifying, with an indecisiveness detector module, a state of a user;
determining, with the indecisiveness detector module, whether the state of the user includes an indecisive behavior;
identifying, with a choice identifier module, a state of an environment of the user;
identifying, with the choice identifier module, a set of available choices from the state of the environment;
receiving, with a processor, a set of past choices and a set of past user decisions relating to the set of past choices; and
generating, with a decision making model, a predicted choice from the set of available choices based on the set of past choices and the set of past user decisions in response to determining that the state of the user includes an indecisive behavior.

2. The method of claim 1, wherein the state of the user comprises:
a visual, a biometric, an interaction, an eye gaze, an audio recording, or combinations thereof.

3. The method of claim 2, wherein determining whether the state of the user includes an indecisive behavior comprises:
identifying a repeated eye gaze on a choice, a repeated interaction with a choice, a lack of interaction with the set of available choices for a threshold period of time, a manual user indication of indecisiveness, or combinations thereof.

4. The method of claim 1, wherein the state of the environment comprises:
a visual, an address, a current time, or combinations thereof.

5. The method of claim 4, wherein identifying the set of available choices from the state of the environment comprises:
generating a set of choices by analyzing, with the choice identifier module, the visual for choices in response to the state of the environment comprising the visual;
generating the set of choices by retrieving, with the processor, a list of choices located at the address in response to the state of the environment comprising the address; and
generating the set of available choices by filtering the set of choices based on the current time.

6. The method of claim 1, wherein generating the predicted choice comprises:
training the decision making model based on at least the set of past choices and the set of past user decisions to predict a decision from the set of available choices.

7. The method of claim 6, wherein generating the predicted choice further comprises:
removing the predicted choice from the set of available choices;
repeating the generating and removing steps for a predetermined number of repetitions to generate a ranked list of predicted choices; and
providing for output onto an electronic display the ranked list of predicted choices.

8. The method of claim 6, further comprising:
receiving a selected choice from the user; and
updating the decision making model to incorporate the selected choice for enhancing subsequent generating of predicted choices.

9. A system for dynamically filtering choices comprising:
a processor;
a memory module communicatively coupled to the processor;
an indecisiveness detector module communicatively coupled to the processor;
a choice identifier module communicatively coupled to the processor;
a decision making model communicatively coupled to the processor; and
a set of machine-readable instructions stored on the memory module that, when executed by the processor, cause the processor to perform operations comprising:
identifying, with the indecisiveness detector module, a state of a user;
determining, with the indecisiveness detector module, whether the state of the user includes an indecisive behavior;
identifying, with the choice identifier module, a state of an environment of the user;
identifying, with the choice identifier module, a set of available choices from the state of the environment;
receiving, with the processor, a set of past choices and a set of past user decisions relating to the set of past choices; and
generating, with the decision making model, a predicted choice from the set of available choices based on the set of past choices and the set of past user decisions in response to determining that the state of the user includes an indecisive behavior.

10. The system of claim 9, wherein the state of the user comprises:
a visual, a biometric, an interaction, an eye gaze, an audio recording, or combinations thereof.

11. The system of claim 10, wherein determining whether the state of the user includes an indecisive behavior comprises:
identifying a repeated eye gaze on a choice, a repeated interaction with a choice, a lack of interaction with the set of available choices for a threshold period of time, a manual user indication of indecisiveness, or combinations thereof.

12. The system of claim 9, wherein the state of the environment comprises:
a visual, an address, a current time, or combinations thereof.

13. The system of claim 12, wherein identifying the set of available choices from the state of the environment comprises:
generating a set of choices by analyzing, with the choice identifier module, the visual for choices in response to the state of the environment comprising the visual;
generating the set of choices by retrieving, with the processor, a list of choices located at the address in response to the state of the environment comprising the address; and
generating the set of available choices by filtering the set of choices based on the current time.

14. The system of claim 9, wherein generating the predicted choice comprises:
training the decision making model based on at least the set of past choices and the set of past user decisions to predict a decision from the set of available choices.

15. The system of claim 14, wherein generating the predicted choice further comprises:
removing the predicted choice from the set of available choices;
repeating the generating and removing steps for a predetermined number of repetitions to generate a ranked list of predicted choices; and
providing for output onto an electronic display the ranked list of predicted choices.

16. The system of claim 14, wherein the set of machine-readable instructions further cause the processor to perform operations comprising:
receiving a selected choice from the user; and
updating the decision making model to incorporate the selected choice for enhancing subsequent generating of predicted choices.

17. A non-transitory machine-readable medium comprising machine-readable instructions that, when executed by a processor, cause the processor to perform operations comprising:
identifying, with an indecisiveness detector module, a state of a user;
determining, with the indecisiveness detector module, whether the state of the user includes an indecisive behavior;
identifying, with a choice identifier module, a state of an environment of the user;
identifying, with the choice identifier module, a set of available choices from the state of the environment;
receiving, with the processor, a set of past choices and a set of past user decisions relating to the set of past choices; and
generating, with a decision making model, a predicted choice from the set of available choices based on the set of past choices and the set of past user decisions in response to determining that the state of the user includes an indecisive behavior.

18. The non-transitory machine-readable medium of claim 17, wherein determining whether the state of the user includes an indecisive behavior comprises:
identifying a repeated eye gaze on a choice, a repeated interaction with a choice, a lack of interaction with the set of available choices for a threshold period of time, a manual user indication of indecisiveness, or combinations thereof.

19. The non-transitory machine-readable medium of claim 17, wherein identifying the set of available choices from the state of the environment comprises:
generating a set of choices by analyzing, with the choice identifier module, a visual of the state of the environment for choices; and
generating the set of available choices by filtering the set of choices based on a current time.

20. The non-transitory machine-readable medium of claim 17, wherein generating the predicted choice comprises:
training the decision making model based on at least the set of past choices and the set of past user decisions to predict a decision from the set of available choices;
removing the predicted choice from the set of available choices;
repeating the generating and removing steps for a predetermined number of repetitions to generate a ranked list of predicted choices;
providing for output onto an electronic display the ranked list of predicted choices;
receiving a selected choice from the user; and
updating the decision making model to incorporate the selected choice for enhancing subsequent generating of predicted choices.
